(19) United States
(12) Patent Application Publication
(10) Pub. No.: US 2003/0165028 A1
(43) Pub. Date: Sep. 4, 2003

(54) Echo producing machine

(76) Inventor: Mike Battle, Akron, OH (US)

Correspondence Address: BROUSE MCDOWELL, 500 First National Tower, 106 S. Main Street, Akron, OH, 44308-1471, US

(21) Appl. No.: 10/345,522

(22) Filed: Jan. 16, 2003

Related U.S. Application Data
(60) Provisional application No. 60/349,171, filed on Jan. 16, 2002.

(51) Int. Cl. G11B 17/00

(52) U.S. Cl. 360/71

(57) ABSTRACT

An improved tape echo reproducing machine is provided having a direct current motor, in place of an alternating current motor, which is coupled to a shaft or other rotating means operatively coupled to a length of recording tape. The direct current motor translates the tape through the machine with greater smoothness, less weight and less heat production, which can damage the tape and reduce the portability of the machine. Further improvements include a Automatic Noise Control, which operates to dampen background, ambient noise from being reproduced along with the inputted sound.

This application claims priority to U.S. Provisional patent application serial No. 60/349,171 filed Jan. 16, 2002.

### 1. BACKGROUND OF THE INVENTION

A. Field of Invention

This invention pertains to the art of methods and apparatuses audio signal conditioning and more specifically to echo producing machines.

B. Description of the Related Art

Echo sound recorders, also known as echo machines, have been well known in the music industry for over fifty years. The principal operation of these machines is to produce a resounding, controllable echo of a musical or other sound input. An echo machine operates by recording sounds onto a media, such as a constantly revolving loop of tape. After the sound is recorded, it is played back again creating an echo effect. The echo produced can be delayed or distorted by other means; however, typically echoes are permitted to simply fade into the background noise or silence after a period of time. By incorporating echoes into musical performances, musicians are able to add secondary levels of sound and depth to their music. Such echoing techniques have been and continue to be an important part of popular music.

Over the decades, echo machines have undergone substantial changes in response to new technologies. Early echo machines relied extensively on loops of tape that passed continuously through recording, erasing and playback heads combined with relatively simplistic circuitry that permitted feedback of the original recorded sound through the playback mechanism. More recent echo machines have relied on digital technology to produce the echoing effect. Despite much improved technology, however, quality tape echo machines, including vintage machines, remain in high demand amongst musicians who appreciate the warmer, richer sound that tape echo machines are believed to have over modem digital echo machines.

Though vintage tape echo machines are still highly prized, and new tape echo machines are still being manufactured, these machines have tended to be heavy units owing to the inclusion of an AC motor and relatively weighty means, including flywheel assemblies, for causing the rotation of the tape through the machine. Furthermore, these machines tend to give off a great amount of heat, which can pose a hazard to the integrity of the machine as well as the tape. The presently existing means of rotating the tape about the machine can cause damage to the tape at the point of contact between the rotating mechanism and the tape. Additionally, presently existing tape echo machines permit a great deal of background and ambient noise into the system, which can result in unwanted and uncontrollable distortion in the sound being produced by the machine.

As a result of these limitations to currently available new and vintage tape echo machines and owing to the perceived higher quality that tape echo machines have over digital or other types of echo machines, what is needed is an echo machine that utilizes a tape, but which is lighter and more reliable, less prone to giving off heat, which rotates the tape through the machine using means that do not damage the tape and which can control to the point of elimination, background and ambient noise.

### II. SUMMARY OF THE INVENTION

In a magnetic sound or like recording device having magnetic tape transducer means and means for driving and guiding the tape past said transducer means, freely-acting means for effecting automatic adjustment of the tape incident to shortening or lengthening of the same so as to restore and maintain uniform tension and of the tape for normal operation thereof, said tape-adjusting means including two duplicate freely rotatable spools mounted in the same plane in substantially parallel relation to each other and multiple superposed convolutions of an endless tape around and rotatable with said spools and extending in elongated loops with substantially spaced parallel sides between and in a plane including said spools and having a single loop take-off portion for direction through said driving and guiding means past said transducer means, said tape-adjusting means being directly effective within and upon said convolutions by operation of said spools, the improvement comprising, wherein the means for driving and guiding the tape comprises: a DC motor having a first output shaft; at least a first tape-contact pin for use in driving the sound-recording magnetic tape; and, wherein the first output shaft is directly connected to the at least a first tape-contact pin and wherein the speed of the first output shaft is selectively adjustable.

A sound recording device having sound-recording magnetic tape transducer means and means for driving and guiding a sound-recording magnetic tape past the transducer means, means for automatically adjusting the sound-recording magnetic tape incident to shortening or lengthening of the same so as to restore and maintain uniform tension of the tape for normal operation thereof, the tape-adjusting means including two duplicate freely rotatable spools mounted in the same plane in substantially parallel relation to each other and multiple superposed convolutions of an endless tape around and rotatable with the spools and extending in elongated loops with substantially spaced parallel sides between and in a plane including the spools and having a single loop take-off portion for direction through the driving and guiding means past the transducer means, the tape-adjusting means being directly effective within and upon the convolutions by operation of the spools, the improvement comprising: circuit noise reducing means for use in reducing noise, the circuit noise reducing means comprising: a photo-coupler; and, a selectively adjustable circuit disconnect means for use in engaging the circuit noise reducing means.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a plan view of the recording interface of the recording device showing the magnetic tape.

FIG. 2 is a plan view of the recording device showing the motor and circuitry.

FIG. 2a is an exploded view of the DC motor and shaft assembly.

FIG. 3 is a schematic representation of the complete circuit diagram of the recording device.

FIG. 4 is a schematic representation of a circuit diagram depicting the signal conditioning circuit.

### IV. DESCRIPTION OF THE PREFERRED EMBODIMENT

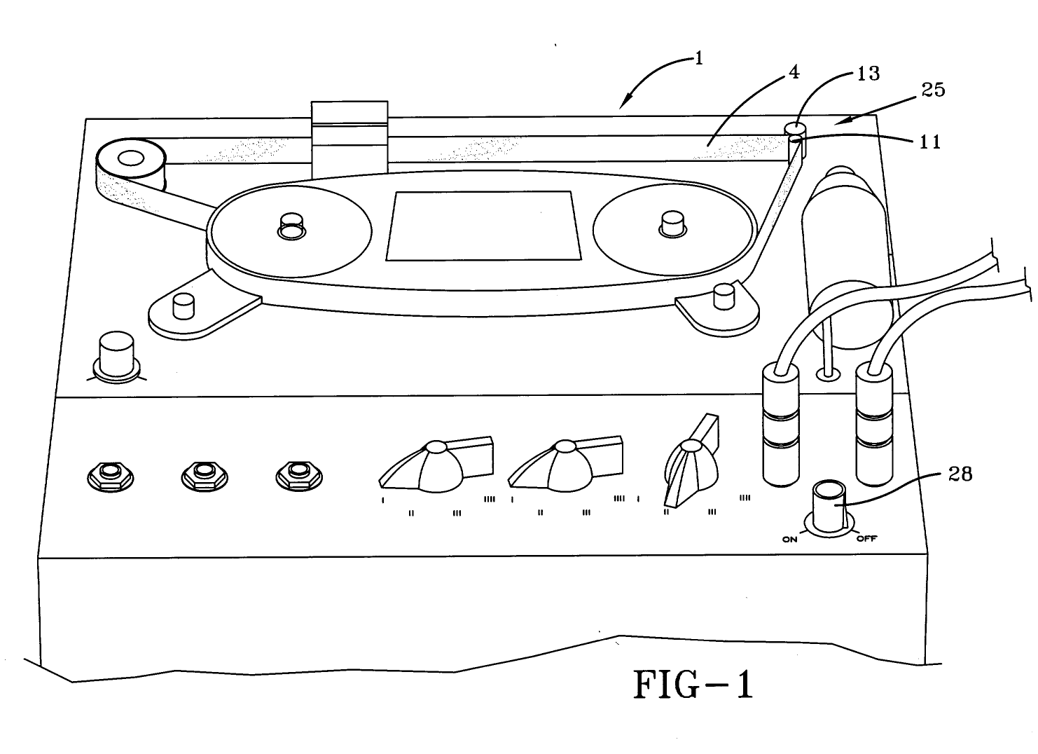

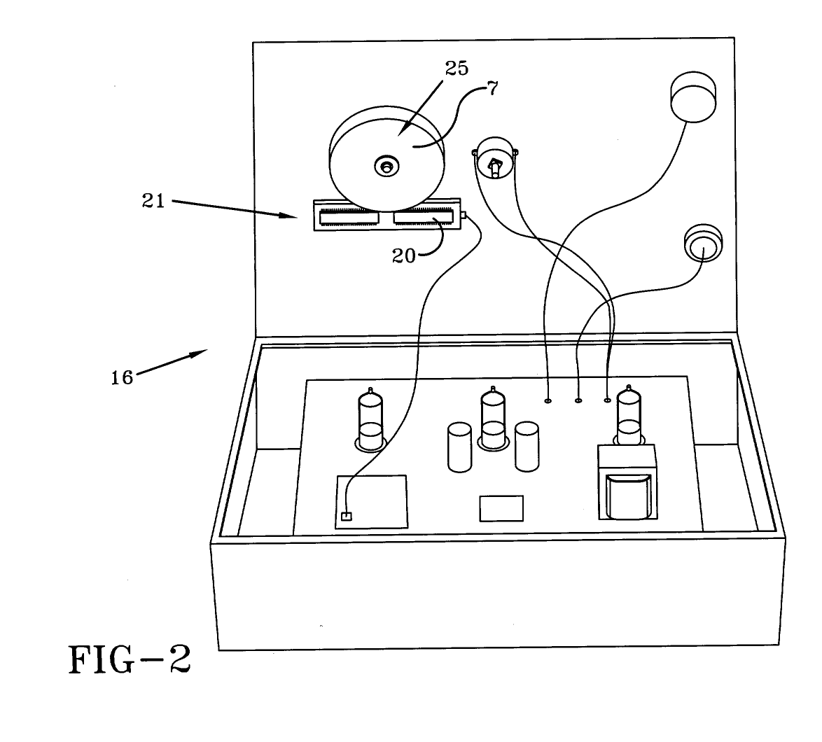

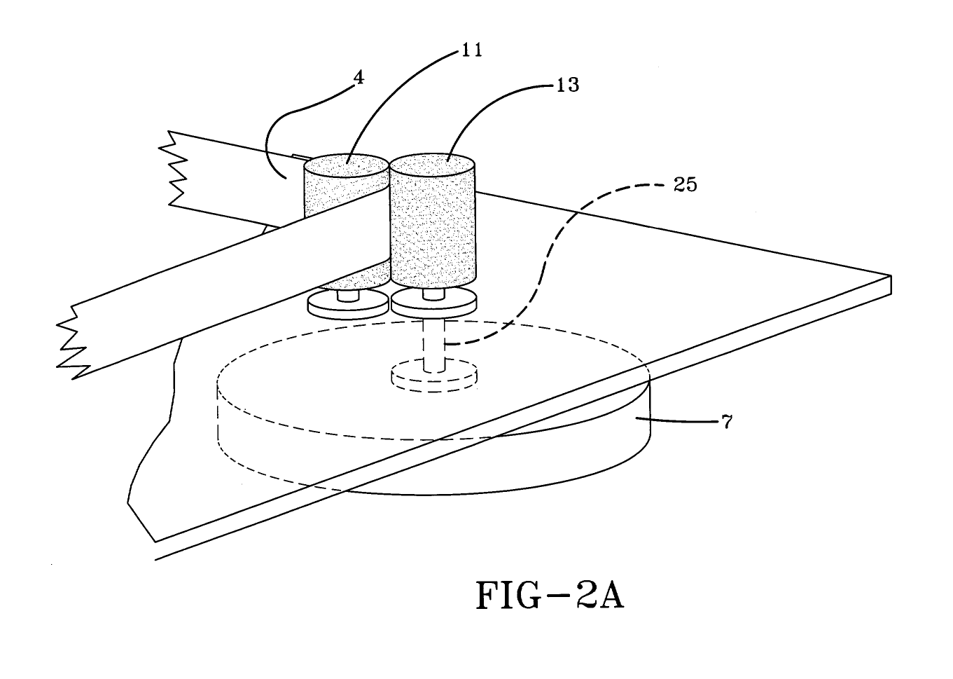

FIGS. 1 and 2 shows an echo producing machine as discussed in U.S. Pat. No. 3,444,330, of which U.S. Pat. No. 3,444,330 is incorporated herein by reference. The provisional patent application serial No. 60/349,171 filed Jan. 16, 2002 from which this application claims priority is herein incorporated by reference. The Echo producing machine 1 includes a magnetic tape 4 configured to run in endless loop. That is to say that the magnetic tape 4 runs continuously. The magnetic tape 4 may be of sufficient length to record 2 minutes of audio signal. However, any length of tape may be used as chosen with sound engineering judgment. The present invention incorporates substantial improvements over the previous Echo producing machine not previously known to the subject art.

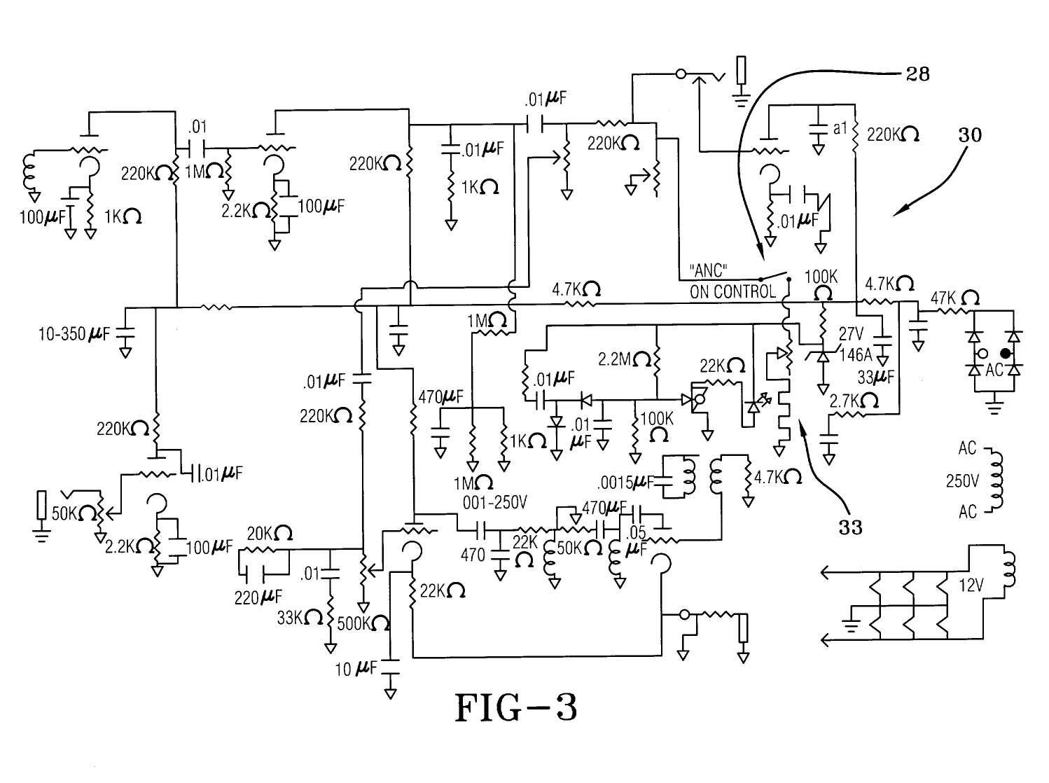

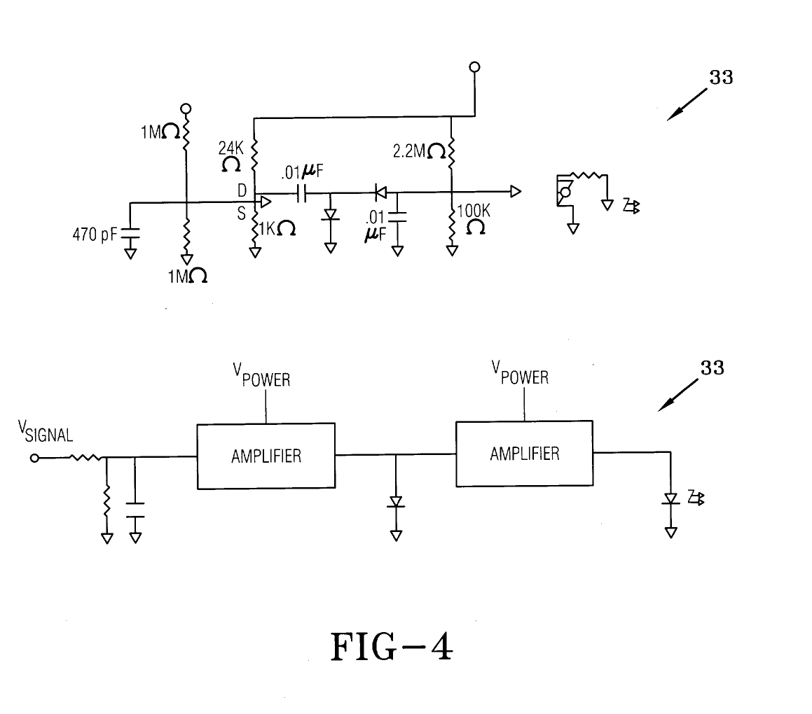

With reference now to FIGS. 1 and 2 and 2a and to FIGS. 3 and 4, an Echo producing machine is shown generally at 1. In one embodiment, the improvement includes replacing the previously known AC electrical motor with a DC brushless motor 7. However, it is noted any type of DC motor 7 may be chosen with sound engineering judgment. The DC brushless motor 7 may be a substantially thin pancake motor configured to operate with minimal operating power for use in reducing heat output generated by operating the motor. The previously known Echo producing machine incorporated an AC motor that was operatively connected to a flywheel assembly, which in turn was connected to a drive wheel. The drive wheel contacted the magnetic tape in such a manner so as to drive the magnetic tape about the previously mentioned endless loop. More specifically, the drive wheel included a cylindrical elastically deformable outer contact head that comes into engaging contact with the tape and provides sufficient friction between the head and the tape so as facilitate driving the tape. In the subject invention, a drive pin 11 is shown juxtaposed to the drive head 13, wherein the drive pin 11 is rotatably mounted with respect to the machine 1. The drive head 13 may also be laterally moveable with respect to the drive pin 11, in a first direction A, to engage and disengage the drive head 13 from driving the tape 4. In this manner, when the drive head 13 is engaged, the tape 4 is disposed between the drive head 13 and the drive pin 11. The tape 4 is driven by rotating the drive head 13, to which drive power is supplied via the motor 7. The fly wheel assembly of the previous Echo producing machine includes multiple fly wheels that altered the output speed of the AC motor to drive the drive head. In that the previous echo producing machine is known in the art, no further explanation will be offered at this point. The improvement of this embodiment, as mentioned includes replacing the existing AC motor with a DC brushless motor 7 that is directly coupled with the drive head 13 and eliminates the fly wheel assembly. The DC brushless motor 7 may be mounted to small circuit board 16, where in the circuit board 16 is attached to the machine as shown in FIG. 2. The motor 7, and circuit board 16, may be received internal to the housing of the machine 1. An IC chip 20, Integrated Circuit chip, may be fixedly attached to the circuit board 16 and electrically communicated thereto so as to control operation of the DC motor 7. The IC chip 20 may be of any type and have any functionality chosen with sound engineering judgment so as a control the motor 7. It is also contemplated in an embodiment that the IC chip 20 may be disposed proximate to the motor 7 and communicated thereto via a smaller secondary circuit board 21. In the preferred embodiment, the IC chip 20 facilitates controlling the speed of the motor 7. In this manner, the motor 7 includes a first output shaft 25 that has a characteristic speed associated therewith which may be selectively adjustable by via a potentiometer, not shown, communicated to the IC chip 20. A tachometer, not shown, may also be included that senses motion and speed of the motor shaft 25 for use in controlling the speed of the motor 7. The DC motor 7 may have an output shaft 25, which may be the rotor member of the motor 7. In the present embodiment, the output shaft 25 is directly coupled to the capstan motor, which in turn drives the heads. In this manner, the fly wheel assembly of the previous echo producing machine may be eliminated. Additionally, the speed of the motor driving the drive head may be selectively adjusted. The benefits of using a DC brushless motor 7 directly coupled to the drive in place of the AC motor may include less operating vibration, less power consumption, greater motor and speed control, smaller space requirements and fewer parts to wear out.

With reference now to FIGS. 1, 2, 2a, 3 and 4, a schematic representation of a second improvement is depicted in FIG. 3 and will now be discussed. There is provided an Automatic Noise Control switch, or ANC switch 28, that may be selectively engageable between first and second positions. The ANC switch 28, shown in FIGS. 1 and schematically in FIG. 3, is communicated with a signal conditioning circuit, wherein the signal conditioning circuit 30 may receive the audio signal of the machine 1. The signal conditioning circuit 30 may include a first amplifier portion and a second signal-rectifying portion. The second signal rectifying portion includes an electrical output that is communicated with an photo transmitting electrical component, which may be an Light Emitting Diode, or L.E.D. A photo conductor 33 member may be disposed in operative proximity to the L.E.D. so as to engage/disengage in response to the L.E.D. The photo conductor 33 may be any electrical conducting device that responds to optical input as chosen with sound engineering judgment. The ANC switch 28 may be directly electrically disposed between the photo conductor 33 and a circuit conducting the source signal. When the ANC switch 28 is engaged or closed, the source signal is connected to ground through the photo-conductor thereby eliminating the source signal from being communicated with the machine audio output. It is noted here that the ANC switch 28 may be set when there is no audio input to the machine. In this manner, the machine is receiving signal noise. When an audio input is connected to the machine, an audio signal is sensed by the circuit and the photo conductor is opened, that is to say not connected to ground and consequently the desired audio signal is communicated to the machine audio output. When the audio signal is not present, the ANC circuit again closes and eliminates the resident noise.

With reference to all of the FIGURES, another improvement of the subject invention is discussed. A standard tube communicated with the circuit 30 that provides recording capabilities and also serves as an oscillator. The oscillator serves two functions. First, the oscillator provides an erase feature that erases high frequency sound. Second, the oscillator provides bias to the audio signal to decrease the distortion in the signal. When the audio signal is generated the sound wave becomes distorted as it approaches zero (every half cycle) by the magnetism generated by the electrical circuit. This distortion is known as hysteresis. The oscillator provides a bias feature that mixes with the signal to eliminate the hysteresis as shown by the audio wave. The resulting wave is a truer sound wave that also has a high frequency component that has a frequency of about 80,000 cycles. It should be noted that the high frequency component is not audible and does not distort the resulting sound wave.

In the previous echo producing machine the solenoid was located inside the machine. During operation of the machine the solenoid would produce a substantial amount of heat due to the lack of air flow within the machine. The excess heat in turn would shorten the life of the electrical components within the machine thereby shortening the life of the machine. In the present invention the solenoid is located on top of the machine. This allows the heat to dissipate in to the air without overheating any other components. The purpose of the solenoid is to dislocate the pinch roller when the record level is initiated to some value thereby preventing the roller to become damaged while not in use.

The preferred embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

Having thus described the invention, it is now claimed:

I/We claim:

1. In a magnetic sound or like recording device having magnetic tape transducer means and means for driving and guiding the tape past said transducer means, freely-acting means for effecting automatic adjustment of the tape incident to shortening or lengthening of the same so as to restore and maintain uniform tension and of the tape for normal operation thereof, said tape-adjusting means including two duplicate freely rotatable spools mounted in the same plane in substantially parallel relation to each other and multiple superposed convolutions of an endless tape around and rotatable with said spools and extending in elongated loops with substantially spaced parallel sides between and in a plane including said spools and having a single loop take-off portion for direction through said driving and guiding means past said transducer means, said tape-adjusting means being directly effective within and upon said convolutions by operation of said spools, the improvement comprising:
wherein the means for driving and guiding the tape comprises:
a DC motor having a first output shaft;
at least a first tape-contact pin for use in driving the sound-recording magnetic tape; and,
wherein the first output shaft is directly connected to the at least a first tape-contact pin.

2. The device of claim 1, wherein the speed of the first output shaft is selectively adjustable.

3. The device of claim 2, further comprising:
at least a first circuit board,
wherein the DC motor is fixedly mounted to the at least a first circuit board.

4. The device of claim 2, further comprising:
a first Integrated Circuit operatively communicated to control the first output of DC motor.

5. A sound recording device having sound-recording magnetic tape transducer means and means for driving and guiding a sound-recording magnetic tape past the transducer means, means for automatically adjusting the sound-recording magnetic tape incident to shortening or lengthening of the same so as to restore and maintain uniform tension of the tape for normal operation thereof, the tape-adjusting means including two duplicate freely rotatable spools mounted in the same plane in substantially parallel relation to each other and multiple superposed convolutions of an endless tape around and rotatable with the spools and extending in elongated loops with substantially spaced parallel sides between and in a plane including the spools and having a single loop take-off portion for direction through the driving and guiding means past the transducer means, the tape-adjusting means being directly effective within and upon the convolutions by operation of the spools, the improvement comprising:
circuit noise reducing means for use in reducing noise, the circuit noise reducing means comprising:
a photocoupler; and,
a selectively adjustable circuit disconnect means for use in engaging the circuit noise reducing means.
